(19) United States
(12) Patent Application Publication
(10) Pub. No.: US 2008/0086656 A1
(43) Pub. Date: Apr. 10, 2008

(54) Electronic Apparatus

(76) Inventor: Kuo-Hsiung Chuang, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/538,817

(22) Filed: Oct. 5, 2006

(51) Int. Cl. G06F 1/04

(52) U.S. Cl. 713/600

(57) ABSTRACT

Disclosed is an electronic apparatus, comprising: an electronic device, operating according to a target clock signal; and a frequency adjusting circuit, for adjusting the target clock signal before the electronic device begins to operate normally, comprising: a reference value generator, for providing at least a first reference value corresponding to an expected frequency of the target clock signal; a comparing module, coupled to the reference value generator, for comparing the reference value and an actual value corresponding to an actual frequency of the target clock signal to generate a comparing result; and an adjusting module, coupled to the comparing module and the controllable clock generator, for adjusting the controllable clock generator according to the comparing result to thereby force the actual frequency to follow the expected frequency.

### BACKGROUND OF THE INVENTION

1. Field of the Invention

The present invention relates to an electronic apparatus, and more particularly, to an electronic apparatus frequency adjusting circuit for adjusting the operation frequency of an electronic device before the electronic device begins normal operation and the system thereof.

2. Description of the Prior Art

Generally speaking, after having applied various processes, the wafer is separated into a plurality of dies. Ideally, each die will have a desired operation frequency when it is provided with the same voltage level. However, it is well know by those having average skill in this art, that the characteristics of the dies are affected by many variables, such as, but not limited to, the condition of the process, the quality of the wafers, and the locations of the dies. Thus, each die may have a different operation frequency even when it is provided with the same voltage level. In this case, the dies that do not have the desired operation frequency are regarded as failed dies and are abandoned (i.e., not usable). Thereby, the cost of manufacturing the dies increase. Further details regarding said manufacturing variations are well known and are therefore omitted hereinafter for the sake of brevity.

In order to decrease the number of failed dies, some manufactures detect the relationship between the locations of the die. Using the die location information, the manufacturers can design a motherboard to provide different voltages to the various dies according to the die location information and the desired operation frequency. However, this method may cause otherwise high quality dies to break due to the high operation frequency or high voltage needed. Additionally, some dies may still fail to achieve the desired operation frequency even when said dies are provided with the predetermined voltage level. This unfortunate event can happen due to many reasons, for example, such as environmental conditions (e.g., temperature). Such kinds of dies, that are otherwise operating correctly, increase the cost of production. Setting the proper operation frequency is an important issue for many other types of electronic devices as well. Thus, an accurate frequency adjusting circuit and method for adjusting the operation frequency of the die is required.

U.S. Pat. No. 6,006,327 discloses an option setting device and method for providing various user-defined settings to a motherboard as shown in FIG. 1. The motherboard 100 includes a CPU 110, a chip set 120 coupled to the CPU 110, a clock generator 150 coupled to the chip set 120, a delay circuit 170 coupled to the chip set 120, a first latching circuit 181 coupled to the chip set 120, and a reset circuit 160 coupled to the delay circuit 170. After the motherboard 100 is powered on, the CPU 110 transfers a first setting via the chip set 120 to the first latching circuit 181 so as to allow the first setting to be latched in the first latching circuit 181. Meanwhile, the CPU 110 also triggers the delay circuit 170 to begin counting time. The delay circuit 170 outputs a trigger signal to the reset circuit 160 after a preset time. The trigger signal causes the reset circuit 160 to restart the motherboard 100. After the motherboard 100 is restarted, the chip set 120 fetches the first setting from the first latching circuit 181 so as to be set accordingly. In the case of the motherboard 100 further having a voltage regulator 165, the option setting device and method further utilizes a second latching circuit 182 for latching a second setting from the CPU 100 and then transferring the latched setting to the voltage regulator 265 to cause the voltage regulator 265 to output a voltage accordingly.

Such systems adjust the operation frequency after the system is powered on, however, the system may not be capable of executing a power on operation successfully if the electronic devices in the system cannot operate with a correct operation frequency. Additionally, the said systems adjust the operation frequency by a software means, thus said systems are not capable of working (i.e., operating) if the system is not capable of operating normally. U.S. Patent 2005/0062507 discloses a similar system as described heretofore, however, the similar system suffers from the same problems.

Thus, it is apparent that new and innovative inventions are required to solve the above-mentioned problems.

### SUMMARY OF THE INVENTION

Therefore, an objective of the present invention is to provide an electronic apparatus with a frequency adjusting circuit for adjusting an operation frequency of an electronic device before the electronic begins normal operation (i.e., is fully powered on).

Another objective of the present invention is to provide a an electronic apparatus with a frequency adjusting circuit for adjusting a target clock signal to follow a reference value generated according to specific hardware configuration of a reference value generator.

Disclosed is an electronic apparatus, comprising: an electronic device, operating according to a target clock signal; and a frequency adjusting circuit, for adjusting the target clock signal before the electronic device begins to operate normally, comprising: a reference value generator, for providing at least a first reference value corresponding to an expected frequency of the target clock signal; a comparing module, coupled to the reference value generator, for comparing the reference value and an actual value corresponding to an actual frequency of the target clock signal to generate a comparing result; and an adjusting module, coupled to the comparing module and the controllable clock generator, for adjusting the controllable clock generator according to the comparing result to thereby force the actual frequency to follow the expected frequency.

The electronic apparatus can be a computer system, which comprises: a storage unit, for storing software for operating the computer system; and a processing unit, coupled to the storage unit and the frequency adjusting circuit, for loading the software for operating the computer system and for controlling the frequency adjusting circuit. The frequency adjusting circuit adjusts the target clock signal before the processing unit loads the software to operate the computer system. Normally, the software is operation system (OS).

According to the above-mentioned description, the production window of the electronic device can be enlarged, and the performance of the electronic device can be improved. Furthermore, the frequency adjusting circuit described above can be further used for other applications in addition to the disclosed adjustment of the electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a prior art option setting device and method for providing various settings to a computer mother board.

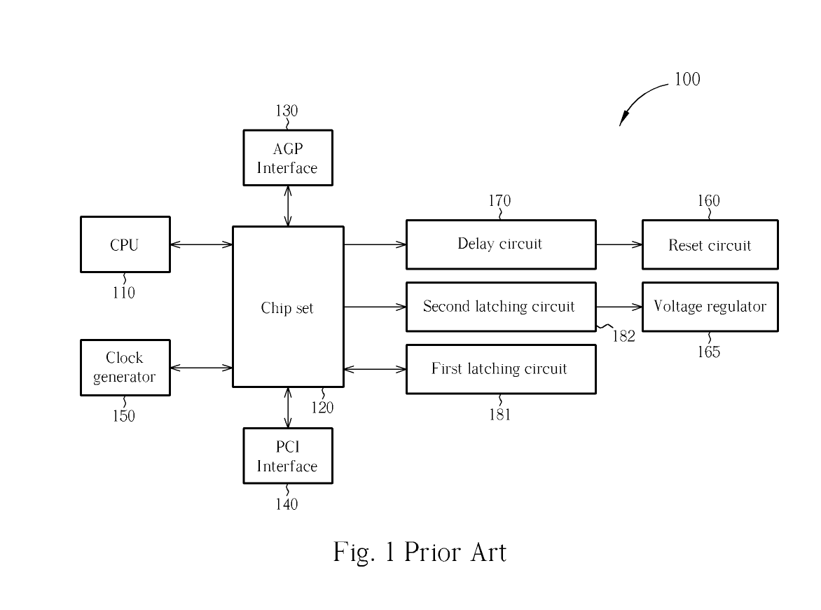

FIG. 2 is a block diagram illustrating a frequency adjusting circuit according to a first preferred embodiment of the present invention.

FIG. 3 is a block diagram illustrating a frequency adjusting circuit according to a second preferred embodiment of the present invention.

FIG. 4 is a circuit diagram illustrating a comparing unit for determining the frequency adjusting circuit shown in FIG. 2 and FIG. 3 should be enabled or not.

FIG. 5 is a flow chart illustrating the frequency adjusting method according to the preferred embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ” Also, the term “couple” is intended to mean either an indirect or direct electrical connection. Accordingly, if one device is coupled to another device, that connection may be through a direct electrical connection, or through an indirect electrical connection via other devices and connections.

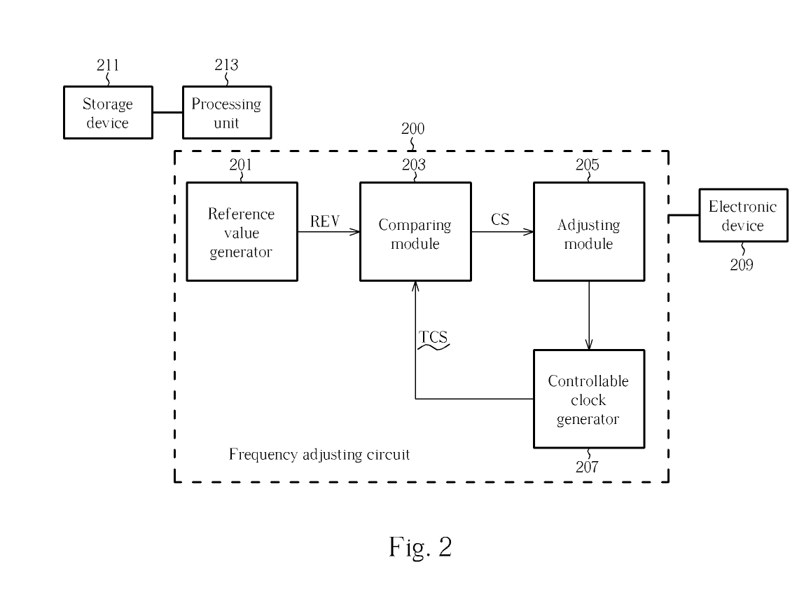

Please refer to FIG. 2. FIG. 2 is a block diagram illustrating a frequency adjusting circuit 200 according to the first preferred embodiment of the present invention. As shown in FIG. 2, the frequency adjusting circuit 200 includes a comparing module 203, an adjusting module 205, and a controllable clock generator 207. The controllable clock generator 207 is used for providing a target clock signal TCS. The reference value generator 201 is used for providing at least a reference value RFV. The comparing module 203, which is coupled to the reference value generator 201, is used for comparing the reference value RFV and an actual value corresponding to an actual frequency of the target clock signal TCS to generate a comparing result CS. The adjusting module 205, which is coupled to the comparing module 205 and the controllable clock generator 207, is used for adjusting the controllable clock generator 207 according to the comparing result CS to thereby make the actual frequency follows the reference value RFV.

The reference value generator 201 can be a device providing a fixed reference value such as a resistor but this is by way of example only and not a limitation of the present invention. Also, the reference value generator 201 can be a device providing a variable reference value such as a jumper, a dip switch or a register but this is by way of example only and not a limitation of the present invention. If the reference value generator 201 is a register, then updating the reference value generator 201 can change the reference value RFV. In other words, the reference value generator 201 provides a reference value RFV according to a specific hardware configuration thereof. In the present invention, the reference value generator 201 provides a reference value by a hardware means instead of a software means but this is by way of example only and not a limitation of the present invention. Since the method for providing the reference value by utilizing the above-mentioned devices are well known by persons having average skilled in this art, further details are hereinafter omitted for the sake of brevity.

It should be noted that the determination of “following the reference value RFV” could depend on the designation of the circuit. For example, the actual value can be adjusted to be equal to or fall within a predetermined range different from the reference value RFV. Alternatively, the reference value generator 201 can further provide another reference value corresponding to another reference frequency of the target clock signal TCS, and the adjusting module 205 can adjust the controllable clock generator 207 according to the comparing result CS to thereby force the actual value to fall within a range defined by the two reference values.

According to the preferred embodiment of the present invention, the frequency adjusting circuit 200 is used for adjusting the frequency of an electronic device 209 on a mother board of a computer system, where the computer comprises a storage device 211 for storing software to operate the computer system, such as operation system (OS), and a processing unit 213 is used for accessing the software stored in the storage device 211 and for controlling the computer system according to the software stored in the storage device 211. The frequency adjusting circuit 200 adjusts the target clock signal TCS before the processing unit 213 loads the software to operate the computer system. In other words, the frequency adjusting circuit 200 adjusts the target clock signal TCS before the electronic device 209 operates normally. In this case, after the computer system operates according to the software stored in the storage device 213 (that is, the electronic device operates normally), the frequency adjusting circuit 200 is turned-off.

Besides, the computer system can further include a monitoring unit (not illustrated) to periodically monitor the operation frequency of the chip to determine if the frequency adjusting circuit 200 should be turned on again or remain in the current turned off state. By this way, the operation frequency can be maintained at a predetermined value or in a predetermined range as desired.

The electronic device 209 can be a chip, that is, a die from a wafer, and the frequency adjusting circuit 200 is located on a mother board of the computer system in this embodiment, but it doesn't mean to limit the scope of the present invention.

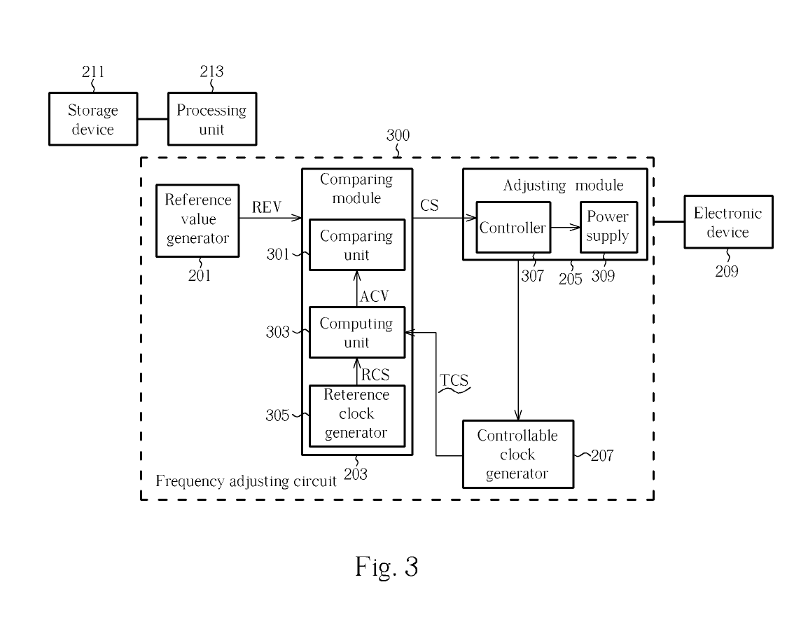

Please refer to FIG. 3, FIG. 3 is a block diagram illustrating a frequency adjusting circuit 300 according to the second preferred embodiment of the present invention. In this embodiment, the computing module 203 shown in FIG. 2 includes a comparing unit 301, a computing unit 303, and a reference clock generator 305, and the adjusting module 205 includes a controller 307 and a power supply 309. The reference clock generator 305 is used for generating a reference clock signal RFC having a fixed frequency. The computing unit 303, which is coupled to the reference clock generator 305 and coupled to the controllable clock generator 207, is used for computing the actual value according to the reference clock signal RCS and the target clock signal TCS. The comparing unit 301, which is coupled to the computing unit 303, is used for comparing the reference value RFV and the actual value ACV to generate the comparing result CS.

According to the preferred embodiment, the computing unit 303 comprises a counter (not illustrated) for sampling the target clock signal TCS to compute the actual value ACV. In this case, the bit number of the counter depends on the actual value. In other words, the bit number of the counter depends on the possible maximum value of the actual value and the possible minimum value of the actual value. By way of example and not limitation, consider that the target clock signal TCS is sampled for computing the actual value for 10 seconds, and the count number in 10 seconds is 512. Therefore, the possible maximum frequency of the target clock signal TCS is regarded as 1024. This is twice the value of the count number, and the preferred bit number of the counter is 10. It should be noted that the time period required by the counter for sampling the target clock signal TCS is offered as an example and is not a limitation of the scope of the present invention.

Furthermore, after the controller 307 controls the power supply 309 to change the control voltage, the control voltage from the power supply 309 may be unstable for a period of time. This in turn causes the target clock signal TCS to be unstable. Thus, counting the target clock signal TCS after the control voltage becomes stable is the preferred operation of the counter. Additionally, the computing unit 303 and the controllable clock generator 207 can be enabled or disabled by the software means or the hardware means for reducing power consumption.

Similarly, the determination of “following the reference value” can depend on the designation of the circuit. For example, the actual value can be adjusted to be equal to or fall within the scope of the reference value RFV. Alternatively, the reference value generator 201 can further provide a second reference value corresponding to another reference frequency of the target clock signal TCS, and the adjusting module 205 can adjust the controllable clock generator 207 according to the comparing result CS to thereby make the actual value fall within a range defined by the first and second reference values.

According to the preferred embodiment of the present invention, the frequency adjusting circuit 300 is located on the mother-board, and is used for adjusting chips on the mother-board, such as dies from a wafer, before the chips operate normally. In other words, the mother board is driven by the office system (OS). In this case, after the chip begins to operate normally, the frequency adjusting circuit 300 is turned-off. The system utilizing the mother-board (for example, a computer) can further include a monitoring unit to periodically monitor the operation frequency of chip to determine if the frequency adjusting circuit 200 should be turned on again or remain in the current turned off state.

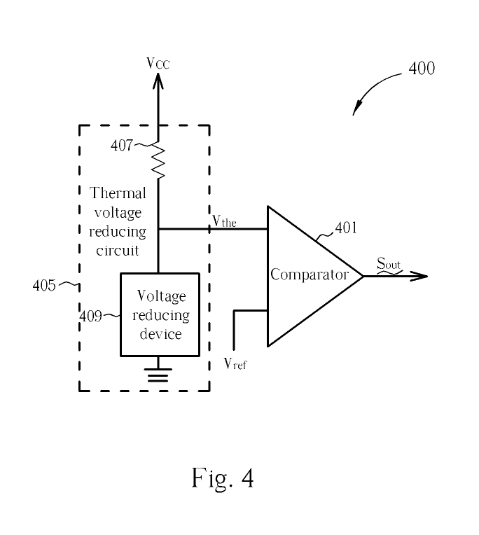

FIG. 4 is a circuit diagram illustrating a comparing unit 400 for determining whether the frequency adjusting circuit shown in FIG. 2 and FIG. 3 should be enabled or not. It should be noted that the comparing unit 400 is only for example and doesn't mean to limit the scope of the present invention.

As shown in FIG. 4, the comparing unit 400 comprises a comparator 401, a voltage source 403, a thermal voltage reducing circuit 405, and a voltage reducing device 407. The voltage source 403 is used for generating a voltage level Vcc. The comparator 401 is used for receiving a thermal voltage Vₜₕₑ corresponding to the temperature of the electronic device 209 at a first input and a reference voltage V_{ref} at a second input and for comparing the thermal voltage Vₜₕₑ and the reference voltage V_{ref} to generate an output signal Sₒᵤₜ to enable the frequency adjusting circuit. The thermal voltage generating circuit 403 is used for generating the thermal voltage according to the voltage level V_{cc} and the temperature of the electronic device 209.

In this case, the thermal voltage generating circuit 403 includes a resistor 407 and a voltage reducing device 409. The resistor 407 has a first end coupled to the voltage source 403 and a second end coupled to the first input of the comparator 401. The voltage reducing device 407, with an end coupled to a second input of the comparator 401 and the second end of the resistor 407, wherein the amount of reduced voltage on the voltage reducing device 409 varies according to the temperature of the electronic device 209. In this case the preferred voltage reducing device 409 is a thermal resistor or a zener diode, but it doesn't mean to limit the scope of the present invention.

It should be noted that the structure of the comparing unit 400 is only for example and doesn't mean to limit the scope of the present invention, the persons skilled in the art can easily modify the structure of the circuit 400 to reach the same function.

In other words, the comparator compares a first signal corresponding to the temperature of the electronic device 209 (the thermal voltage Vₜₕₑ) and a second signal (V_{ref}) to generate an output signal Sₒᵤₜ to enable the frequency adjusting circuit 200 or 300. Also, the comparing unit 400 can compare a first signal and a second signal to generate an output signal corresponding to the temperature of the electronic device 209 to enable the frequency adjusting circuit 200 or 300. It also falls in the scope of the present invention.

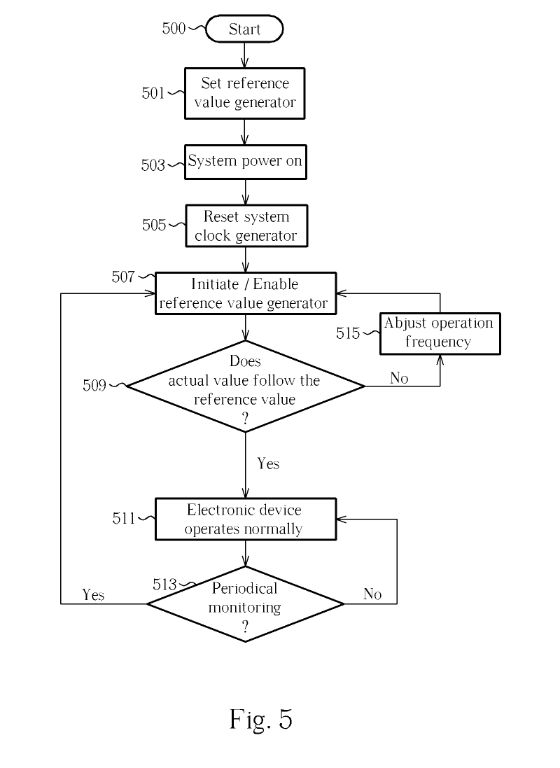

Please refer to FIG. 5. FIG. 5 is a flow chart illustrating the steps of the operation method corresponding to the circuit shown in FIG. 2 and FIG. 3. It should be noted that FIG. 5 is provided for illustrating the operation of the circuit shown in FIG. 2 and FIG. 3 and is not intended to limit the scope of the present invention.

The method includes:

Step 500: Start.

Step 501:

Set reference value generator.

Step 503:

Power on the system utilizing the frequency adjusting circuit.

Step 505:

Reset the system clock generator.

Step 507:

Initiate/Enable the reference value generator.

Step 509:

Is the actual value following the reference value? If yes, go to step 511, if no, go to step 515.

Step 511:

Determine that the electronic device is operating normally.

Step 513:

Is periodic monitoring needed? If no, go back to step 511, if yes, go to step 507 to initiate the reference value generator.

It should be noted that if the reference value generator is a register or any electronic device with the same or similar function, then the reference value could be further updated after step 503.

According to above-mentioned system and method, the operation frequency of the chip can be maintained at a suitable value or in a suitable range, thereby the process window of the chip can be increased and the cost of manufacturing can be reduced. It should be noted that the above-mentioned system and method could be further used for other electronic devices or for other applications. For example, utilizing the above-mentioned system and method for reducing the power consumption of an electronic system also falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic apparatus comprising:
an electronic device, operating according to a target clock signal; and
a frequency adjusting circuit, for adjusting the target clock signal before the electronic device begins to operate normally, comprising:
a reference value generator, for providing at least a first reference value corresponding to an expected frequency of the target clock signal;
a comparing module, coupled to the reference value generator, for comparing the reference value and an actual value corresponding to an actual frequency of the target clock signal to generate a comparing result; and
an adjusting module, coupled to the comparing module and the controllable clock generator, for adjusting the controllable clock generator according to the comparing result to thereby force the actual frequency to follow the expected frequency.

2. The electronic apparatus of claim 1, wherein the reference value generator comprises a specific hardware for determining a first reference value.

3. The electronic apparatus of claim 2, wherein the reference value generator is a jumper, a dip switch, or a register.

4. The electronic apparatus of claim 1, wherein the adjusting module comprises:
a controller, coupled to the comparing module, for generating a control signal according to the comparing result; and
a power supply, coupled to the controller and the controllable clock generator, for generating a control voltage to control the controllable clock generator.

5. The electronic apparatus of claim 3, wherein the comparing module comprises:
a reference clock generator, for generating a reference clock signal having a fixed frequency;
a computing unit, coupled to the reference clock generator and the controllable clock generator, for computing the actual value according to the reference clock signal and the target clock signal; and
a comparing unit, coupled to the computing unit, for generating the comparing result.

6. The electronic apparatus of claim 5, wherein the computing unit comprises a counter to sample the target clock signal for the computing of the actual value.

7. The electronic apparatus of claim 6, wherein is a type of counter having a bit number depending on the actual value.

8. The electronic apparatus of claim 7, wherein the bit number of the counter depends on the possible maximum value and the possible minimum value of the actual value.

9. The electronic apparatus of claim 5, wherein the adjusting module comprises:
a controller, coupled to the comparing module, for generating a control signal according to the comparing result; and
a power supply, coupled to the controller and the controllable clock generator, for generating a control voltage to control the controllable clock generator.

10. The electronic apparatus of claim 9, wherein the computing unit computes the actual value after the power supply provides a stable control voltage to control the controllable clock generator.

11. The electronic apparatus of claim 1, wherein the reference value generator further provides a second reference value corresponding to another expected frequency of the target clock signal, and the adjusting module adjusts the controllable clock generator according to the comparing result to thereby force the actual value fall within a range defined by the first and second reference values.

12. The electronic apparatus of claim 1, wherein the adjusting module adjusts the controllable clock generator according to the comparing result to thereby force the actual value match the expected value.

13. The electronic apparatus of claim 1, being a motherboard.

14. The electronic apparatus of claim 1, wherein the electronic device is a chip.

15. The electronic apparatus of claim 1, further comprising a monitoring unit for monitoring an operation frequency of the electronic device after the electronic device operates normally to determine if the adjusting module should adjust the operation frequency of the electronic device or not.

16. The electronic apparatus of claim 1, further comprising a comparing unit for comparing a first signal and a second signal to generate an output signal corresponding to the temperature of the electronic device to enable the frequency adjusting circuit.

17. The electronic apparatus of claim 1, further comprising a comparing unit for comparing a first signal corresponding to the temperature of the electronic device and a second signal to generate an output signal to enable the frequency adjusting circuit.

18. The electronic apparatus of claim 17, wherein the first signal is a thermal voltage corresponding to the temperature of the electronic device and the second signal is a reference voltage.

19. The electronic apparatus of claim 18, wherein the comparing unit comprises:
a voltage source, for generating a voltage level;
a thermal voltage generating circuit, for generating the thermal voltage according to the voltage level and the temperature of the electronic device.
a comparator, having a first input coupled to the thermal voltage generating circuit, for receiving a thermal voltage corresponding to the temperature of the electronic device at a first input and a reference voltage at a second input and for comparing the thermal voltage and the reference voltage to generate an output signal to enable the frequency adjusting circuit.

20. The electronic apparatus of claim 18, wherein the thermal voltage generating circuit comprises:
a resistor, with a first end coupled to the voltage source and a second end coupled to a first input of the comparator;
a voltage reducing device, coupled to a second input of the comparator and the second end of the resistor, wherein the amount of reducing voltage on voltage reducing device varies according to the temperature of the electronic device.

21. The electronic apparatus of claim 20, wherein the voltage reducing device is a thermal resistor or a zener diode.

22. The electronic apparatus of claim 1, being a computer system, comprising:
a storage unit, for storing software for operating the computer system; and
a processing unit, coupled to the storage unit and the frequency adjusting circuit, for loading the software for operating the computer system and for controlling the frequency adjusting circuit;
wherein the frequency adjusting circuit adjusts the target clock signal before the processing unit loads the software to operate the computer system.

23. The electronic apparatus of claim 22, wherein the software is operation system (OS).
